(19) United States
(12) Patent Application Publication
(10) Pub. No.: US 2007/0046435 A1
(43) Pub. Date: Mar. 1, 2007

(54) Biologically modeled RF ID tags

(76) Inventors: Roger A. Fratti, Mohnton, PA (US); Warren K. Waskiewicz, Clinton, NJ (US)

Correspondence Address: Docket Administrator;Agere Systems Inc., Room 4U-533C, 4 Connell Drive, Berkeley Heights, NJ, 07922-2747, US

(21) Appl. No.: 11/214,262

(22) Filed: Aug. 29, 2005

(51) Int. Cl. H04Q 5/22

(52) U.S. Cl. 340/10.2; 340/10.5

(57) ABSTRACT

RFID tags include circuitry operable to receive an input signal from a common transceiver and generate at least first and second signals, a first signal adapted to transmit information to the common transceiver and a second signal adapted to transmit information to adjacent RFID tags. The second adapted signal is received by the adjacent RFID tags and used to control their operation wherein they are temporarily disabled. During the time that the adjacent RFID tags are disabled, the first RFID tag communicates with the common transceiver via the first signal. When communication is complete the first RFID tags temporarily disable themselves allowing the adjacent RFID tags to be enabled and communicate with the common transceiver. In this manner only limited numbers of RFID tags are transmitting at one time thereby limiting the amount of RF power impinging upon the common transceiver. Spreading the RF power received by the common transceiver over time reduces the probability that the common transceiver will be overloaded or saturated improving the data transmission between RFID tags and common transceiver.

### FIELD OF THE INVENTION

The present invention relates generally to radio frequency identification (RFID) tags, and more particularly to techniques for improving the data transmission to and from multiple tags in environments with many tags closely spaced wherein the data transmission to and from multiple tags includes the querying of tags for counting or inventorying tasks by a common transceiver unit.

### BACKGROUND OF THE INVENTION

Due to the increasing use of RFID tags in commercial applications the density of tags in any given space will increase. This increase in the density of tags comes about, for example, as RFID tags transition from being used to tag pallets to being used to tag individual items contained on a pallet. A single common transceiver unit sends an input signal to a single RFID tag. The RFID tag responds and transmits signal energy back to the common transceiver unit. When there are hundreds or thousands of RFID tags in a given space and within range of a single common transceiver unit, as a common transceiver unit transmits signal energy, many RFID tags may respond simultaneously. The simultaneous response of many RFID tags can overwhelm the common transceiver unit.

RFID tags, which are well known in the art, have been implemented with various designs. A typical RFID tag 100 is illustrated in FIG. 1. The RFID tag 100 consists of a transmitter 102 and receiver 104. Transmitter 102 and receiver 104 may be powered from a power source 106. In some applications the power source 106 may be a battery or a wired power supply. The RFID tag 100 also contains an antenna network 108 which is coupled to the transmitter and receiver. The antenna is used to radiate electrical signals back to a common transceiver and detect signals from a common transceiver.

Another known variation of the power source, for providing operation and transmit signal energy is illustrated in FIG. 2. As shown in the figure, the power source 206 uses a portion of the received radio frequency (RF) signal energy to power the RFID tag 200. The received input signal energy is coupled through an antenna network 208 and rectified by a diode 210. Diode 210 is part of the power source 206. The rectified or DC signal generated by power source 206 supplies the power to the RFID tag 200. One advantage of using the rectified input signal to power the tag is that batteries or external power sources are not required which can reduce the cost of the RFID tag. RFID tags employing this method of power source are commonly used for employee badges or other personal identification means.

### SUMMARY OF THE INVENTION

An example of the invention will be described for one typical RFID tag that uses rectified input signal energy to power the RFID tag. This RFID tag 300 is illustrated in FIG. 3. As described before, the RFID tag employs an antenna network 308 with rectifying diode 310. An input signal, 312, from a common transceiver unit 316 hits the RFID tag, the input signal energy is rectified by diode 310 contained in power source 306. The rectified signal energy powers the transmitter 302, receiver 304 and all other circuitry of RFID tag 300. While this discussion describes the use of a RFID tag which is powered by the input signal energy it should be understood that it will work for other powering methods.

One form of communication between the common transceiver unit 316 and the RFID tag 300 can be achieved by a method called back scatter. The common transceiver transmits input signal energy 312. This input signal energy is received by the RFID tag 300. Once RFID tag 300 is powered up, the circuitry within the tag, transmitter 302 can modulate the current through the diode 310. This current modulation changes the impedance of diode 310. Diode 310 is coupled to antenna network 308. The change in impedance affects the reflection characteristics of the antenna network 308. The resulting reflected, or backscattered first signal energy 314, will be phase modulated. This phase modulated signal is then received by the common transceiver unit 316. The RFID tag 300 may be programmed to phase modulate a signal with a particular binary code. The binary code is received by the common transceiver unit 303 and decoded. The information contained in the binary code may be serial number information, manufacture date or other pertinent information used for inventory control. In addition to the backscattered first signal energy, the RFID tag sends out a second signal 318. This second signal is transmitted to control the operation and function of other RFID tags located in the nearby space. The second signal is received by adjacent RFID tags with the adjacent RFID tag being disabled upon the receipt of the second signal.

The RFID tag is also enabled to determine the signal characteristics of a second signal. The RFID tag can then modify aspects of its operation based on the determined characteristics of the second. The characteristics of operation that can be modified include disablement time or modulation characteristics of the second signal.

### BRIEF DESCRIPTION OF THE DRAWINGS

These and other features and advantages of the present invention will become apparent from the following detailed description of illustrative embodiments thereof, which is to be read in connection with the accompanying drawings in which

FIG. 1 is a high level schematic diagram illustrating a conventional RFID tag;

FIG. 2 is a high level schematic diagram illustrating a conventional RFID tag which employs an RF rectifier that generates DC signals to power the RFID tag;

FIG. 3 is a flow diagram depicting the interaction of a common transceiver and RFID tag;

FIG. 4 is a flow diagram depicting the interaction of a common transceiver and many RFID tags in a dense environment;

FIG. 5 is a schematic diagram depicting an exemplary RFID tag, formed in accordance with an illustrative embodiment of the present invention; and

FIG. 6 is a flow diagram illustrating the interaction between a common transceiver and a plurality of the RFID tags shown in FIG. 5.

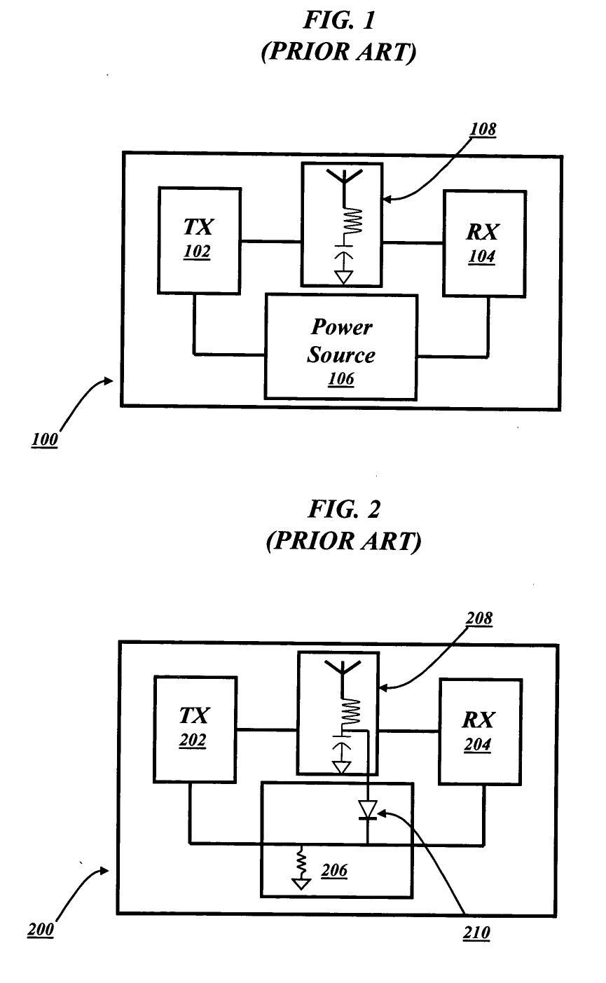

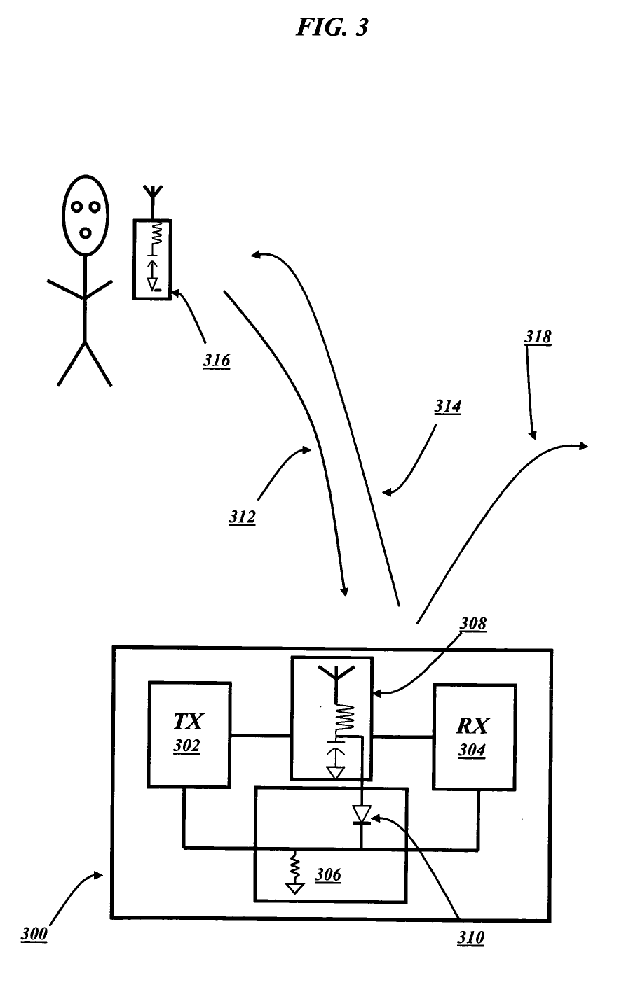

### DETAILED DESCRIPTION OF THE INVENTION

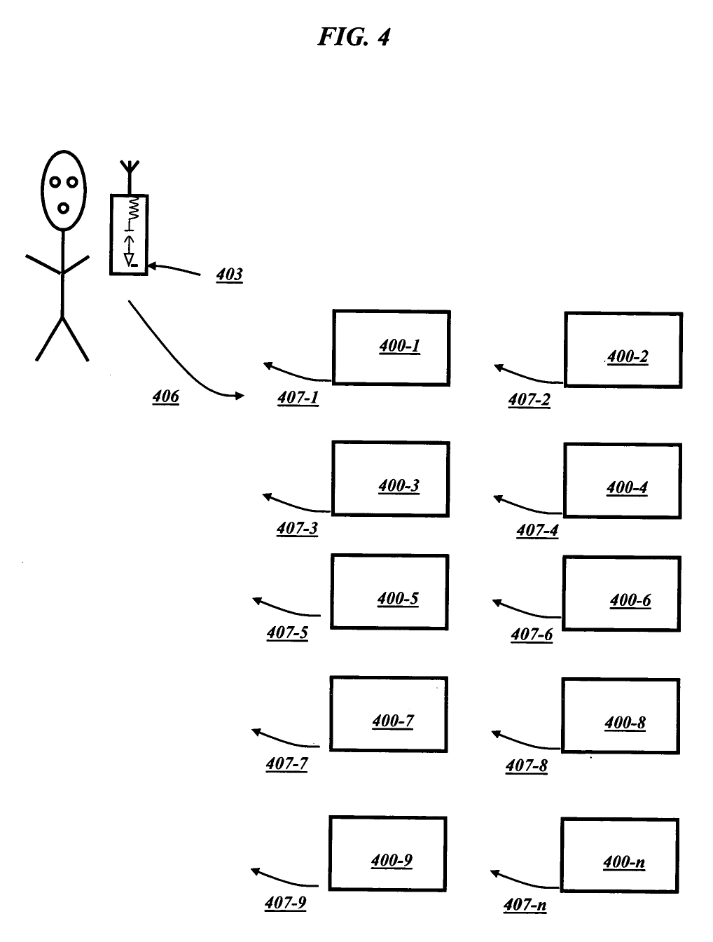

An environment with a high density of RFID tags coexisting is shown in FIG. 4. The illustrated RFID tags can be any known RFID tag designs using any of the described methods of powering. In addition the method of modulation is not limited to the backscatter approach previously described. One skilled in the art would be able to modify the circuitry of the RFID tag to employ various modulation schemes. These modulations schemes include, but are not limited to, amplitude modulation (AM), phase modulation (PM), frequency hopping spread spectrum (FHSS), frequency modulation (FM), pulse code modulation (PCM), discrete multitone modulation (DMTM) and code division multiple access modulation (CDMA).

In such an environment, shown in FIG. 4, a common transceiver, when transmitting, may simultaneously activate many RFID tags 400-1 through 400-n. This simultaneous transmission of signal energy by the many RFID tags crowds the radio frequency spectrum. The frequency spectrum becomes crowded as the total power increases in the frequency band used by the receiver portion of the common transceiver. Another example of the radio frequency spectrum becoming crowded is the overlapping of multiple signals that generate unwanted mixing products in the receiver portion of the common transceiver.

A third example of crowding of the spectrum increases the signal level received by the common transceiver for RFID tags powered by a battery or other power supply. The crowding of the spectrum for back scattered signals 407-1 through 407-n is caused by the substantially simultaneous transmission of overlapping of backscattered bit streams. This crowding of the backscattered spectrum creates critical issues with the reception of the signals by the common transceiver 403. As the spectrum becomes crowded, the power in the frequency band increases. Increased power can saturate the common transceiver's receiving circuitry, which in turn decreases the common transceiver's ability to properly receive the transmitted information from each of the RFID tags 400.

The present invention, in an illustrative embodiment, provides techniques for beneficially extending the number of RFID tags a common transceiver can communicate with by limiting the amount of RF signal energy that a common transceiver has to handle. RFID tags include circuitry operable to receive an input signal from a common transceiver and generate at least first and second signals, a first signal adapted to transmit information to the common transceiver and a second signal adapted to transmit information to adjacent RFID tags. The second adapted signal is received by the adjacent RFID tags and used to control their operation wherein they are temporarily disabled. During the time that the adjacent RFID tags are disabled, the first RFID tag communicates with the common transceiver. When communication is complete the first RFID tags temporarily disable themselves allowing the adjacent RFID tags to be enabled and communicate with the common transceiver. In this manner only limited numbers of RFID tags are transmitting at one time thereby limiting the amount of RF power impinging upon the common transceiver. Spreading the RF power received by the common transceiver over time reduces the probability that the common transceiver will be overloaded or saturated improving the data transmission between RFID tags and common transceiver.

The interaction and interrelationship between the tags can be thought of being similar to that of mole rats. In a mole rat population, the dominant female rat will excrete hormones which keep the other females from breeding. Upon expiration of the dominant female mole rat, another mole rat will take its place and become the dominant female mole rat. This is analogous to one RFID tag responding first and becoming the dominant RFID tag. This dominant RFID tag excretes a second signal which temporarily suppresses the other tags. Once the dominant tag completes communications it temporarily expires allowing other RFID tags to become temporarily dominant.

The present invention will be described in the context of an illustrative RFID tag which may be used, for example, in an inventory control application. It should be appreciated, however, that the present invention is not limited to the particular RFID tag architecture shown, nor are the techniques of the invention limited to any specific application. Rather, the invention is more generally applicable to improving the ability of a common transceiver to communicate with large numbers of RFID tags, and conversely large numbers of RFID tags to communicate with a common transceiver, without significantly degrading the quality of communications between the common transceiver and RFID tags.

The term “common transceiver” as used herein essentially refers to a radio frequency device that is used to communicate with RFID tags by transmitting an information containing signal, and in response thereto receiving and decoding information-containing signals from RFID tags.

The term “RFID tag” as used herein refers to a radio frequency transmitter and receiver device that is associated with an item wherein the RFID tag may contain information about the item. Such information may be unique to the item, for example a serial number, or generic information, such as “I'm a box of soap; count me as one box of soap”. Alternatively the information may be some combination of both unique and generic information.

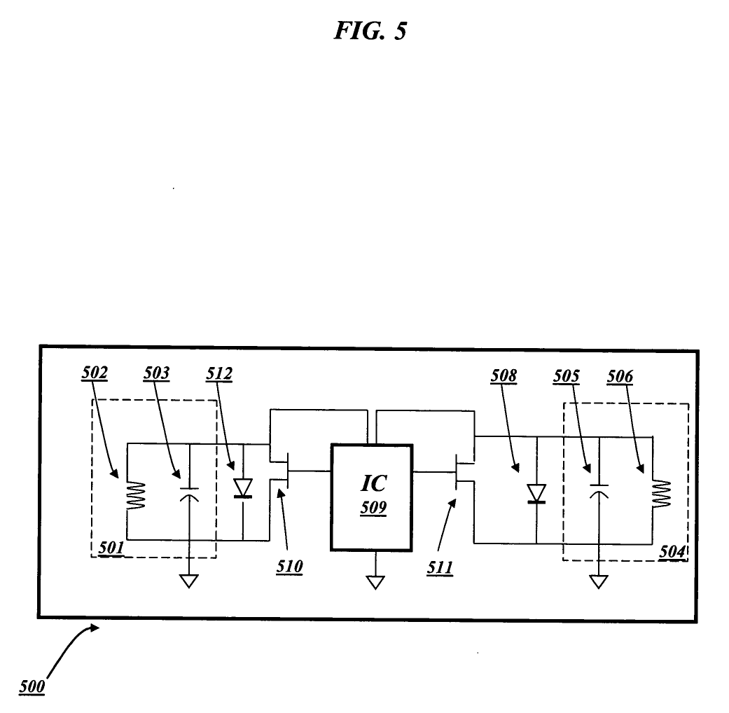

FIG. 5 is a schematic diagram depicting an exemplary RFID tag 500 in which the techniques of the present invention are implemented, in accordance with an illustrative embodiment thereof. RFID tag 500 includes a tank circuit 501, which is comprised of an inductor 502 and capacitor 503 that determine resonant frequency of the tank according to the relation Fres₁≈1/(2*π*√(L₅₀₂*C₅₀₃)). A second tank circuit 504 is similarly comprised of an inductor 506 and capacitor 505 which determine the resonant frequency of the said second tank according to the relation Fres₂≈1/(2*π*√(L₅₀₇*C₅₀₆)). Coupled to respective tank circuit 501 and tank circuit 504 are diodes 512 and 508. By way of example FIG. 5 shows the diodes to be coupled to the tank circuits in a parallel manner. It is to be appreciated that the invention is not limited to the coupling shown. Rather, alternative serial coupling may be similarly employed as will become apparent to those skilled in the art.

Additional circuitry coupled to the tank circuits includes transistor 510, transistor 511 and integrated circuit 509. At least a portion of the RFID tag of the present invention may be implemented in an integrated circuit. In forming integrated circuits, a plurality of identical die are typically fabricated in a repeated pattern on a surface of a semiconductor wafer. One skilled in the art would know how to dice wafers and package die to aid in the implementation of this invention. In addition one skilled in the art would know as well how to partition the circuitry appropriately to include within the integrated circuit the aforementioned tank circuit elements, 502, 503, 506, 507, and other elements 512, 508,509,510 and 511.

Signals intended to be detected by RFID tag 500 are within a specified frequency range of the resonant frequency of tank circuit 501 such that they are detectable. The detectable input signals are determined by the selectivity of the tank circuit, the sensitivity of the receiving circuitry contained within IC 509, background noise, local thermal noise and many other electrical parameters with which one skilled in the art would be familiar. It should be understood that the resonant frequencies of tank circuit 501 and tank circuit 504 may not be exactly equal; either by design or by variations in process and fabrication parameters, but the frequency range of both tank circuits may contain overlapping, contiguous or distinctly different frequencies.

Alternate embodiments of RFID tags include IC 509 processed in large batches of wafers where the process is intentionally altered to induce differences in RF sensitivity of the receiving circuitry. This is commonly done for design tolerance experiments (DTE) where various IC wafer processing parameters are modified to force the performance of an integrated circuit to different levels. The use of DTE can force differences in RF sensitivity so that large numbers of tags will contain members with greater sensitivity while other RFID circuits contain less sensitivity to ensure initial dominant behavior of some tags.

Other parameters can be modified by the induced process spread from the DTE. Other parameters include, but are not limited to, the time the RFID transmitter takes to start transmitting or the time the RFID receiver takes to start decoding information.

Another method of forcing differences in RF sensitivity of the receiving circuitry among large numbers of RFID tags would be to fabricate them with tank circuits having different resonant frequencies or quality factors. The quality factor of a resonant tank is related to the amount of loss in the tank inductor. RF sensitivity is proportional to the amount of loss in a tank inductor.

The RFID tag 500 is preferably configured such that incoming input signals to RFID tag 500 are received by at least one of the tank circuits. For discussion purposes only, the first tank circuit herein will be considered tank circuit 501. If the RFID tag employs no separate power source, this RF energy can be rectified by diode 512 to generate sufficient DC power to operate the circuitry of the RFID tag. The circuitry of the RFID tag includes IC 509 transistors 510 and 511 and diodes 512 and 508. Once the RFID tag is operating, the IC 509 will at least partially control the RFID tag 500 in a manner consistent with one or more modes of operation. Subsequent descriptions of operation will assume that the RFID tag has been supplied with sufficient DC power to function properly.

A first mode of operation for the RFID tag is when an input signal transmitted from a common transceiver is received by a first tank circuit 501. The signal is decoded by IC 509 and then transmits a second signal from a second tank circuit 504. This second signal may be thought of as the equivalent of the dominant female mole rat's suppressing hormones. As previously discussed, the modulation techniques can take one of many numerous forms such as amplitude modulation (AM), phase modulation (PM), frequency hopping spread spectrum (FHSS), frequency modulation (FM), pulse code modulation (PCM), discrete multitone modulation (DMTM) and code division multiple access modulation (CDMA). Therefore the second signal may be of the same frequency as the first signal but with different modulation or coding employed to differentiate it from the first signal. Upon the successful completion of communication with the common transceiver the RFID tag disables the first tank. This can be accomplished by the IC 509 turning on transistor 510. Transistor 510, in the on state, provides a low impedance across the tank circuit 501 thereby detuning and the tank resonant frequency such that it no longer functions as a receiving element for the RFID tag.

A second mode of operation for the RFID tag is when a second signal from an adjacent RFID tag is received on tank circuit 504. The signal is decoded by IC 509. The decoding of the signal includes the generation of a disable signal. The IC 509 or other circuitry is triggered by this disable signal to then turn on transistor 510 which provides a low impedance across the tank circuit 501 keeping the RFID tag from communicating with a common transceiver. This allows the adjacent RFID tag, which transmitted the second signal, to complete communication with the common transceiver. After a predetermined time period, the tank circuit 501 is enabled and the RFID tag will attempt to communicate with the common transceiver unless it receives additional second signals transmitted from adjacent RFID tags via tank circuit 504.

By way of example the generation of the second signal will now be described. The frequency ranges of tank circuits 501 and 504 may overlap, be contiguous or be separated by some guard band. In one embodiment an input signal transmitted from a common transceiver, received by tank circuit 501 may be frequency doubled by IC 509. The resulting doubled frequency is essentially a second harmonic of the input signal frequency which may be transmitted by tank circuit 504. Frequency doubling techniques are known by those skilled in the art and can often be done with simple diode based circuitry.

Other methods of generating a signal to be transmitted by tank 504 may require an internal clock or frequency synthesizers within IC 509. With current state of the art integrated circuit techniques extremely high levels of complexity can be implemented without detrimentally impacting the cost of the RFID tag. (see, e.g., R. Glidden et al., “Design of Ultra-Low-Cost UHF RFID Tags for Supply Chain Applications,” IEEE Communications Magazine, August 2004, pp. 140-151, the disclosure of which is incorporated by reference herein).

Although described above as an on-off switch, transistor 511 is not limited thereto. IC 509 may modulate the current in tank circuit 504 by controlling transistor 511 as an amplifying element. IC 509 may also modulate the current in diode 508 to detune tank circuit 504, for the case where IC 509 has frequency doubled the signal transmitted from the common transceiver to perform on-off keying of the second transmitted signal. IC 509 may also reverse bias diode 508 to alter the total capacitance of tank circuit 504 thereby implementing a frequency modulation (FM) second transmitted signal.

For RFID tags wherein the IC 509 employs frequency synthesizers, internal clocks or external crystal based clocks, more complex generation the second transmitted signal may be performed. If for example the resonant frequencies of tank circuits 501 and 504 overlap, the second signal may be a frequency hopping signal while the input signal and first signal may be a binary phase shift keyed (BPSK) signal. The distinction between these signals can easily be made by IC 509 which would employ different demodulation circuitry. Another example would be where tank circuit 501 receives a frequency modulated signal (FM) and IC 509 transmits amplitude modulated (AM) signals.

The duration of time that IC 509 disables either tank circuit 501 or tank circuit 504 may be a fixed predetermined amount of time or a variable amount of time. For less complex circuitry, IC 509 may employ a simple RC time constant for determining the length of time transistor 510 and transistor 511 are used to disable, respectively tank circuit 501 and tank circuit 504. The determination of the time constant ultimately depends upon the final application of the RFID tag. For more complex circuitry, RFID tags employing crystal based clocks or frequency synthesizers may have the duration of time that IC 509 disables either tank circuit 501 or tank circuit 504 predetermined by a fixed or variable number of clock cycles.

The communication time in the following examples is a time that passes which includes the transmit time from the common transceiver to the RFID tag, the time required by the RFID to respond and transmit information back to the common transceiver, additional time required by both the common transceiver or RFID tag to power up and process information and any time required by the RFID tag to transmit a second signal for disabling adjacent RFID tags.

By way of example only, and without loss of generality, for a RFID tag application where 1000 tags are expected to be collocated with a typical communication time between RFID tag and common transceiver of 1 mS, where the common transceiver can simultaneously handle 10 RFID tags an appropriate time to disable the RFID tag from transmitting would be 200 mS. This would allow a common transceiver to query 10 tags at a time for 100 mS with the first 10 tags disabled beyond the total communication time. For this example the total communication time would be a minimum of 100 mS and the stated 200 mS time is appropriate in that it offers a safety factor of 2.

Variable durations of disablement time, determined by either RC time constants within IC 509 or by the number of clock cycles of a frequency synthesizer or crystal based clock within IC 509 may be set external factors. RFID tags not employing fixed durations of time, may have the variable duration at least partially determined by the number of collocated tags. For example, in a dense environment with many RFID tags located in the same space, the input signal transmitted from the common transceiver may be received by many RFID tags. If a large number of tags simultaneously respond to the input signal and send out a large number of first and second signals, the power level of the cumulative second signal may be greater than it would be if only a small number of tags initially responded. The RFID tags that did not initially respond to the input signal transmitted from the common transceiver, but which are responding to the cumulative second signal, may identify aspects of the second signal, such as the power level, and modify their disablement time accordingly. Increasing the disablement time when receiving higher power levels of the second transmitted signal can limit the number of active RFID tags since portions of the RFID tag population will remain disabled for a greater time.

For example, an RFID tag may initially start out with a disable time of 200 mS. In a dense environment the RFID tag may receive a cumulative power level on the second transmitted signal which it compares to known reference levels. Based on the comparison to the reference level the time of disablement for the RFID may be change in some deterministic or random manner.

Although illustrative embodiments of the present invention have been described herein with reference to the accompanying drawings, it is to be understood that the invention is not limited to those precise embodiments, and that various other changes and modifications may be made therein by one skilled in the art without departing from the scope or spirit of the invention.

What is claimed is:

1. A radio frequency identification (RFID) tag, comprising:
an antenna circuit operable to receive an input frequency and a second RF signal;
a first receiver circuit adapted to receive input from the antenna circuit and generate an output disable signal;
a first transmitter circuit adapted to transmit a first RF signal and the second RF signal;
a disable circuit adapted to receive the output disable signal and temporarily disable the first transmitter circuit from transmitting the first RF signal when the first receiver receives the second RF signal.

2. The RFID tag of claim 1, wherein the transmission of a second RF signal is implemented with a backscatter technique.

3. The RFID tag of claim 1, wherein the RFID tag employs a resistor-capacitor time constant for setting the duration of disablement of the first transmitter.

4. The RFID tag of claim 1, wherein the RFID tag employs a count of clock cycles for setting the duration of disablement of the first transmitter.

5. The RFID tag of claim 1, wherein the resonant frequency of a first tank is substantially the same as the resonant frequency of a second tank.

6. The RFID tag of claim 1, wherein the modulation of the first RF signal is different relative to the second RF signal.

7. The RFID tag of claim 1, further comprising a plurality of the antenna circuits, a plurality of the receiver circuits, a plurality of the transmitter circuits and a plurality of the disable circuits.

8. A method of implementing radio frequency identification of RFID tags, comprising: transmitting information from a transceiver;
said transceiver receiving information from a plurality of RFID tags, said plurality of RFID tags communicating with the transceiver in one mode and communicating with adjacent RFID tags in a second mode.

9. The method of claim 8, wherein transmitting a second RF signal is implemented with a backscatter technique.

10. The method of claim 8, wherein the second mode initiates the temporary disabling of the adjacent RFID tag.

11. A method of implementing radio frequency identification, comprising the steps of:
receiving an input frequency signal and a second RF signal on an antenna, transmitting a first RF signal and a second RF signal in response there to receiving the input frequency,
generating an output disable signal in response there to receiving the second RF signal, the output disable signal temporarily disabling the generation of the first RF signal.
